(19) United States
(12) Patent Application Publication
(10) Pub. No.: US 2004/0033096 A1
(43) Pub. Date: Feb. 19, 2004

(54) Portable keyboard

(76) Inventors: Su-Duek Choi, Changan-Gu (KR); Nan-Yoc Jo, Guri-Si (KR)

Correspondence Address: PENNIE & EDMONDS LLP, 1667 K STREET NW, SUITE 1000, WASHINGTON, DC, 20006

(21) Appl. No.: 10/291,648

(22) Filed: Nov. 12, 2002

(30) Foreign Application Priority Data
Aug. 16, 2002 (KR) 2002-48548

(51) Int. Cl. B41J 5/12

(52) U.S. Cl. 400/472

(57) ABSTRACT

Disclosed is a portable keyboard having a compact folded size with a thin profile and a light weight so as to be easy to carry and use. The portable keyboard comprises a plurality of laterally arranged main frames provided with a key pad attached thereto, a sub-frame longitudinally connected to one main frame selected from the plural main frames and provided with a folding holder, and a connector connected to the main frame where the sub-frame is longitudinally connected, wherein the main frame comprises first, second, and third main frames, the sub-frame is connected to the second main frame, and the first main frame is rotatably connected to the second main frame by a first link block and the third main frame is rotatably connected to the second main frame by a second link block being longer than the first link block.

### BACKGROUND OF THE INVENTION

1. Field of the Invention

The present invention relates to a portable keyboard, and more particularly to a portable keyboard having a compact folded size with a thin profile and a light weight so as to be easy to carry and use, and comprising a rotatably-operated connector so as to be easily connected to various kinds of portable communication terminals, and a holder for more firmly and stably holding the portable communication terminals.

2. Description of the Related Art

As well known to those skilled in the art, portable keyboards are foldably opened and closed, thereby being easy to carry and use. The conventional portable keyboards are used in PDAs (Personal Digital Assistants), and one configuration of conventional portable keyboards is shown in FIGS. 6 to 8c.

FIG. 6 is a perspective view of a conventional portable keyboard. As shown in FIG. 6, the conventional portable keyboard comprises five laterally arranged main frames 101, 102, 103, 104, and 105 including numerous keys 106, a sub-frame 107 longitudinally connected to the second main fame 102, and hinge axes 110 for folding the main frames 101, 102, 103, 104, and 105 and sub-frames 107. Further, a holder 108 for supporting the rear surface of a PDA (100 shown in FIG. 7) is installed within the sub-frame 107. Both terminals of a connector 109 connected to the PDA 100 are fixed to the second main frame 102 by bolts.

The aforementioned conventional portable keyboard is folded in the manner shown in FIGS. 8a to 8c. First, as shown in FIG. 8a, the first main frame 101 is folded into the second main frame 102, and the fifth main frame 105 is folded into the fourth main frame 104. Then, as shown in FIG. 8b, the folded portion of the fifth main frame 105 into the fourth main frame 104 is folded into the folded portion of the first main frame 101 into the second main frame 102 by using the third main frame 103 interposed between the second and fourth main frames 102 and 104 as a hinge. Next, as shown in FIGS. 8c, the sub-frame 107 is folded into the compactly folded main frames 101, 102, 103, 104, and 105 so as to cover the folded main frames 101, 102, 103, 104, and 105, thereby completing the folding process of the conventional portable keyboard.

In the conventional portable keyboard, since the five main frames are laterally connected to each other by the parallel-arranged hinge axes and are folded centering around the hinge axes so as to be closed as the compactly folded condition, the folded conventional portable keyboard is comparatively thick and heavy, thereby being inconvenient to carry and handle.

And, since the connector of the conventional portable keyboard is fixed to an extension of the main frame by the bolts, the conventional portable keyboard cannot be universally connected to various kinds of PDAs.

Further, since the holder of the conventional portable keyboard is flat-type and supports a rear surface of a PDA by point contact using supporting protrusions formed on its both ends, the conventional portable key board cannot firmly and securely support the PDA.

Moreover, since a key pad is attached and fixed to the main frames of the conventional portable keyboard only by bolts, it is difficult or inconvenient to disassemble the main frames of the conventional portable keyboard.

### SUMMARY OF THE INVENTION

Therefore, the present invention has been made in view of the above problems, and it is an object of the present invention to provide a portable keyboard having a compact folded size with a thin profile and a light weight so as to be easy to carry and use.

It is a further object of the present invention to provide a portable keyboard comprising a rotatably-operated connector so as to be easily connected to various kinds of portable communication terminals.

It is another object of the present invention to provide a portable keyboard comprising a holder for more firmly and stably holding a portable communication terminal.

It is yet another object of the present invention to provide a portable keyboard in which a key pad is fixed to main frames without bolts so as to more swiftly and easily attach/detach the key pad to/from the main frames.

In accordance with the present invention, the above and other objects can be accomplished by the provision of a portable keyboard comprising a plurality of laterally arranged main frames provided with a key pad attached thereto, a sub-frame longitudinally connected to one main frame selected from the plural main frames and provided with a folding holder, and a connector connected to the main frame where the sub-frame is longitudinally connected, wherein the main frame comprises first, second, and third main frames, the sub-frame is connected to the second main frame, and the first main frame is rotatably connected to the second main frame by a first link block and the third main frame is rotatably connected to the second main frame by a second link block being longer than the first link block.

Preferably, an extension may be formed on one side of the second main frame, the extension may comprise a supporting protrusion upwardly protruded from its both ends and front and rear insertion holes with opened upper ends formed on both external side surfaces of the supporting protrusions, hinge axes inwardly protruding from the inner surfaces of both ends of the sub-frame may be rotatably inserted into the corresponding front insertion holes of the supporting protrusions, and hinge protrusions protruding from both ends of the connector may be rotatably inserted into the corresponding rear insertion holes of the supporting protrusions.

Further, preferably, a holder may be disposed within the sub-frame, the holder may comprise both supporting plates and a horizontal bar for interconnecting two supporting plates to each other, formed on the upper surfaces of the supporting plates, a rotary protrusion may be protruded from the external side surface of each supporting plate so as to be inserted into a rotary protrusion insertion hole formed on both inner surfaces of the sub-frame, an incline place may be formed on the rear portion of the lower surface of the each supporting plate so as to be supported by a supporting knoll protruded from the inner surface of the sub-frame in front of each rotary protrusion insertion hole, and fixing protrusions may be formed on the holder 41 at the upper position of the rotary protrusions and fixing protrusions may be formed on the sub-frame.

Moreover, a plurality of fixing holes may be formed at several locations of the key pad, a plurality of hooks may be formed on the bottom surfaces of the first, second, and third main frames so as to correspond to the fixing holes of the key pad, and the key pad may be attached to the first, second, and third main frames by only inserting the hooks into the corresponding fixing holes.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic perspective view of a portable keyboard in a state of use in accordance with the present invention;

FIG. 2 is an exploded perspective view of the portable keyboard in accordance with the present invention;

FIG. 3 is an exploded perspective view showing an assembled structure of the portable keyboard in accordance with the present invention;

FIG. 4 is a cross-sectional view of the portable keyboard in a compactly folded condition in accordance with the present invention;

FIGS. 5a and 5f are perspective views illustrating a process for folding the portable keyboard in accordance with the present invention, and more particularly:

FIGS. 5a and 5b are perspective views illustrating a step for folding a first main frame;

FIGS. 5c and 5d are perspective views illustrating a step for folding a third main frame; and

FIGS. 5e and 5f are perspective views illustrating a step for folding a sub-frame;

FIG. 6 is a perspective view of a conventional portable keyboard;

FIG. 7 is a perspective view of the conventional portable keyboard of FIG. 6 in a state of use; and

FIG. 8a to 8c are perspective views illustrating a process for folding the conventional portable keyboard, and more particularly:

FIG. 8a is a perspective view illustrating a step for folding a first main frame and a fifth main frame into a second main frame and a fourth main frame, respectively;

FIG. 8b is a perspective view illustrating a step for folding the folded portion of the fifth main frame into the fourth main frame into the folded portion of the first main frame into the second main frame; and

FIG. 8c is a perspective view illustrating a step for covering the folded main frames with a sub-frame.

### DESCRIPTION OF THE PREFERRED EMBODIMENTS

Now, preferred embodiments of the present invention will be described in detail with reference to the annexed drawings.

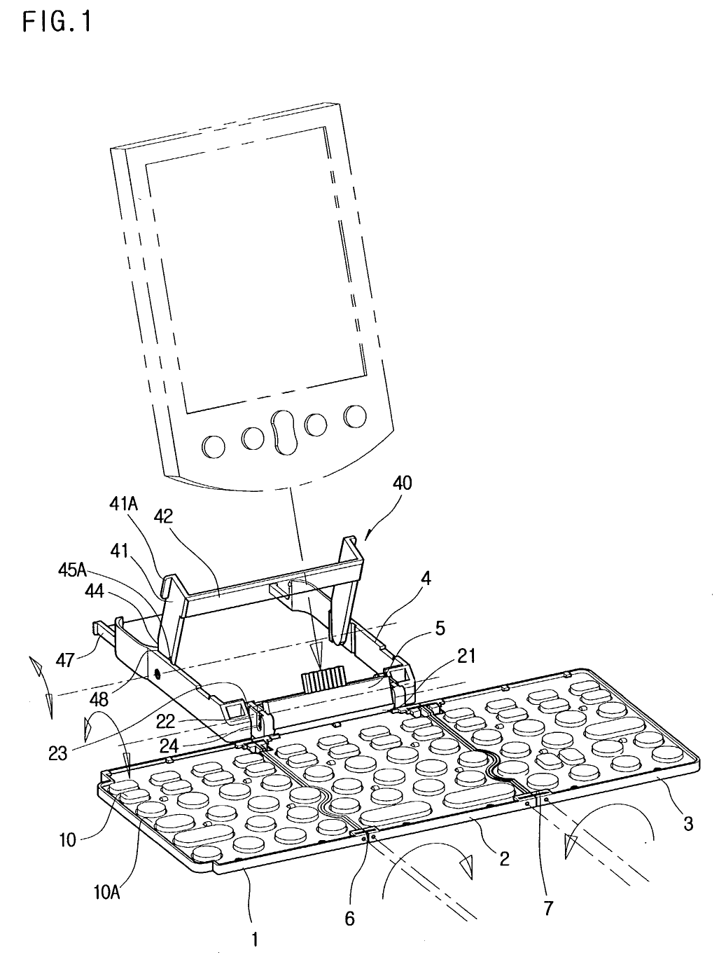

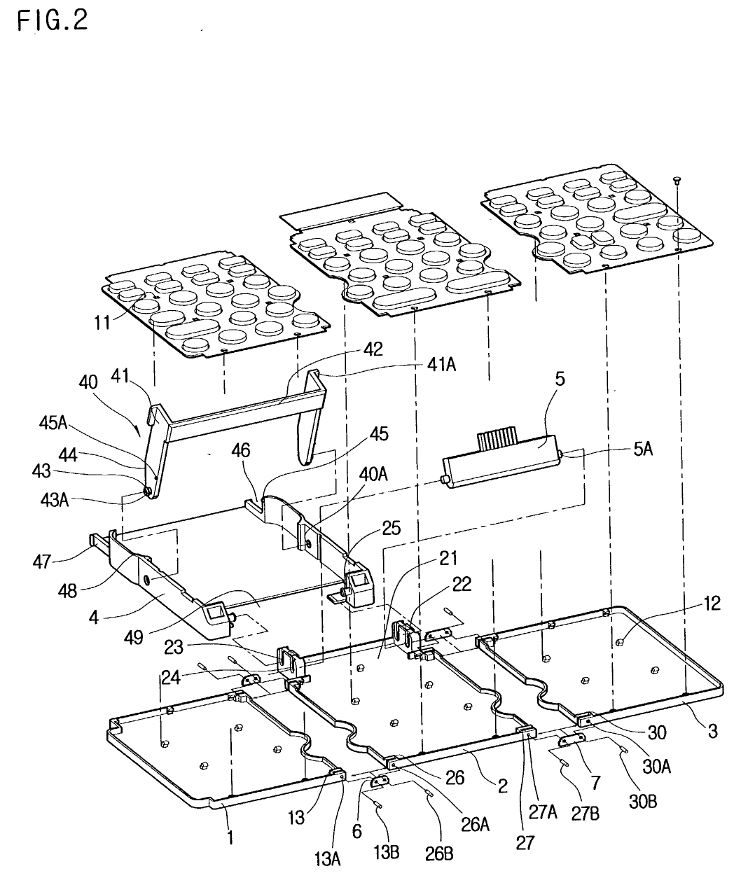

FIGS. 1 and 2 are respectively a schematic view and an exploded perspective view of a portable keyboard in accordance with the present invention.

As shown in FIGS. 1 and 2, the portable keyboard of the present invention comprises three main frames, i.e., first, second, and third main frames 1, 2, and 3, a sub-frame 4, a first link block 6, and a second link block 7. The first, second, and third main frames 1, 2, and 3 are laterally arranged. The sub-frame 4 is longitudinally arranged on the second main frame 2. The first and second main frames 1 and 2 are interconnected to each other by the first link block 6, and the second and third main frames 2 and 3 are interconnected to each other by the second link block 7. Herein, the second link block 7 is longer than the first link block 6.

More specifically, the first and second link blocks 6 and 7 are bar-shaped. A first link insertion groove A 13 with an opened terminal is formed on both ends of a side surface of the first main frame 1, and a first link insertion groove B 26 with an opened terminal is formed on both ends of a side surface of the second main frame 2. The side surface of the first main frame 1 provided with the both first link insertion grooves A 13 is opposite to the side surface of the second main frame 2 provided with the both first link insertion grooves B 26. A second link insertion groove A 27 with an opened terminal is formed on both ends of the other side surface of the second main frame 2, and a second link insertion groove B 30 is formed on both ends of a side surface of the third main frame 3. The side surface of the second main frame 2 provided with the both second link insertion grooves A 27 is opposite to the side surface of the third main frame 3 provided with the both second link insertion grooves B 30.

The first link block 6 is inserted into the first link insertion groove A 13 and the first link insertion groove B 26, and rotatably fixed to the first and second main frames 1 and 2 by a first hinge pin A 13B and a first hinge pin B. The second link block 7 is inserted into the second link insertion groove A 27 and the second link insertion groove B 30, and rotatably fixed to the second and third main frames 2 and 3 by a second hinge pin A 27B and a second hinge pin B 30B. As described above, the second link block 7 is longer than the first link block 6. Therefore, in order to receive the second link block 7, the second link insertion groove A 27 and the second link insertion groove B 30 are longer than the first link insertion groove A 13 and the first link insertion groove B 26. Herein, reference numeral 13A denotes a first hinge hole A for receiving the first hinge pin A 13B, reference numeral 26A denotes a first hinge hole B for receiving the first hinge pin B 26B. Reference numeral 27A denotes a second hinge hole A for receiving the second hinge pin A 27B, and reference numeral 30A denotes a second hinge hole B for receiving the second hinge pin B 30B.

An extension 21 is formed on one side of the second main frame 20. A supporting protrusion 22 is upwardly protruded from both ends of the extension 21, and a front insertion hole 23 and a rear insertion hole 24 are formed on both external side surfaces of the supporting protrusions 22. The upper ends of the front and rear insertion holes 23 and 24 are opened. Hinge axes 25 inwardly protruding from the inner surfaces of both ends of the sub-frame 4 are rotatably inserted into the corresponding front insertion holes 23. Hinge protrusions 5A protruding from both ends of the connector 5 are rotatably inserted into the corresponding rear insertion holes 24.

A rotary protrusion insertion hole 40A is formed on both inner surfaces of the sub-frame 4. A supporting knoll 48 is protruded from the inner surface of the sub-frame 4 in front of each rotary protrusion insertion hole 40A. A holder 40 disposed within the sub-frame 4 comprises both supporting plates 41 and a horizontal bar 42 for interconnecting two supporting plates 41 to each other. Each supporting plate 41 is provided with a fixing protrusion 45A. The horizontal bar 42 is formed on the upper surfaces of the supporting plates 41. Herein, the horizontal bar 42 is integrally formed with the supporting plates 41. An incline place 44 is formed on the rear portion of the lower surface of the each supporting plate 41 so as to be supported by the supporting knoll 48. A rotary protrusion 43 is protruded from the external side surface of each supporting plate 41. The rotary protrusions 43 are rotatably inserted into the corresponding rotary protrusion insertion hole 40A of the sub-frame 4. A slot 43A is formed on the center of the top surface of each rotary protrusion 43, thereby providing an elastic force to the rotary protrusion 43.

Herein, reference numeral 41A is a knob for pulling the holder 40, and reference numeral 47 is a knob formed on a space 46. Reference numeral 49 is an opening for preventing the connecter 5 from interfering with the sub-frame 4.

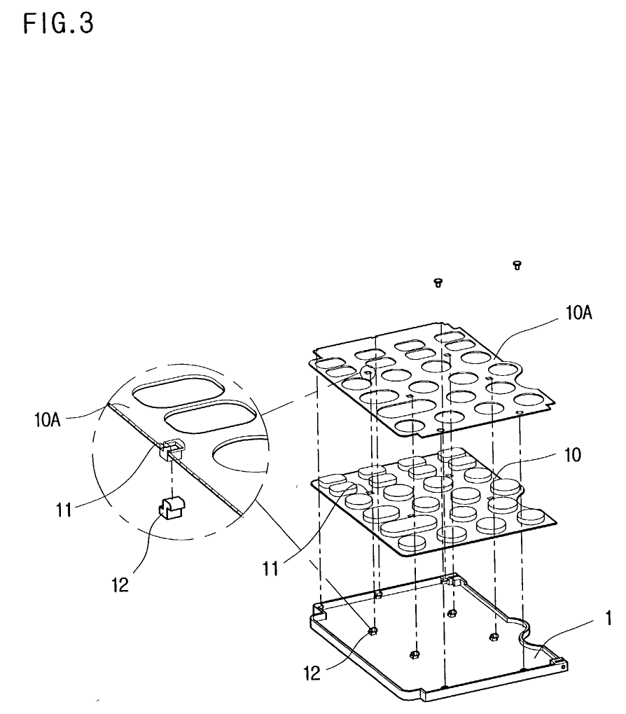

The first, second, and third main frames 1, 2, and 3 are provided with a key pad 10 including a plurality of keys formed thereon. A plurality of fixing holes 11 are formed at several location of the key pad 10, and a plurality of hooks 12 are formed on the bottom surfaces of the first, second, and third main frames 1, 2, and 3 so as to correspond to the fixing holes 11 of the key pad 10. Therefore, the key pad 11 can be attached to the first, second, and third main frames 1, 2, and 3 by only inserting the hooks 12 into the corresponding fixing holes 11 without bolts. An upper plate 10A of the key pad 10 is made of a metal (with reference to FIG. 3).

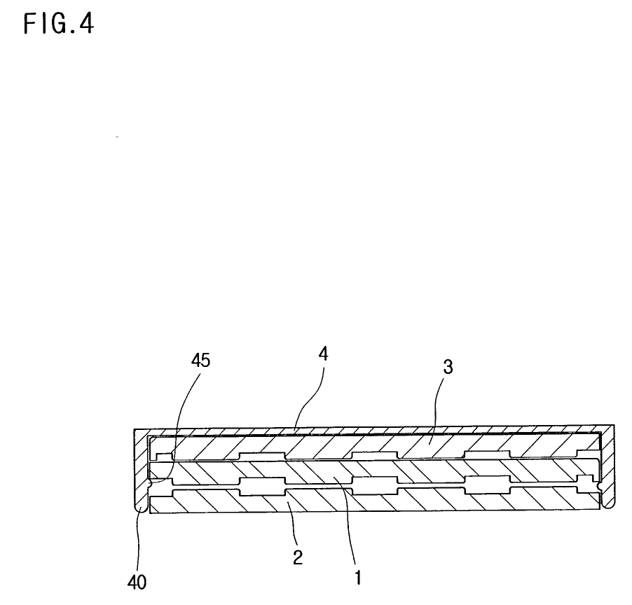

FIG. 4 is a cross-sectional view showing a folded condition of the portable keyboard of the present invention. As shown in FIG. 4, the first main frame 1 is folded into the second main frame 2, and then the third main frame 3 is folded thereinto. Next, the sub-frame 4 is folded into the compactly folded structure of the first, second, and third main frames 1, 2, and 3 so as to cover the folded structure. Herein, the folded condition is maintained by inserting fixing protrusions 45 inwardly protruding from designated positions of the both inner side surfaces of the sub-frame 4 into a gap in a profile formed by folding first main frame 1 into the second main frame 2.

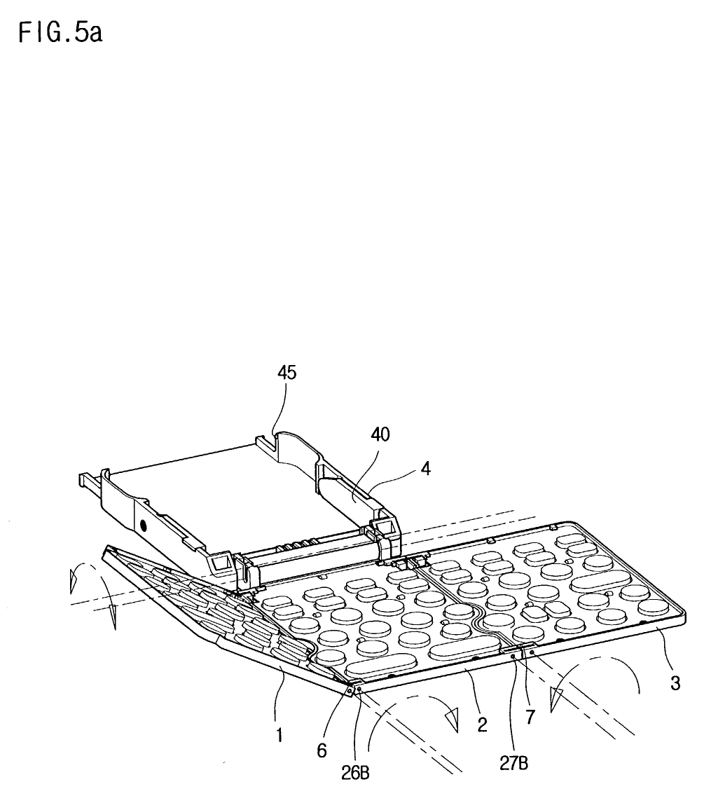

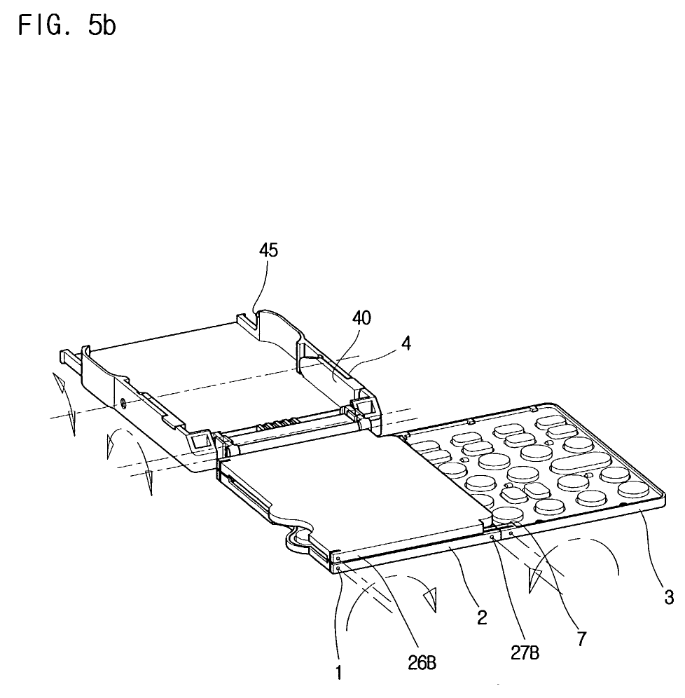

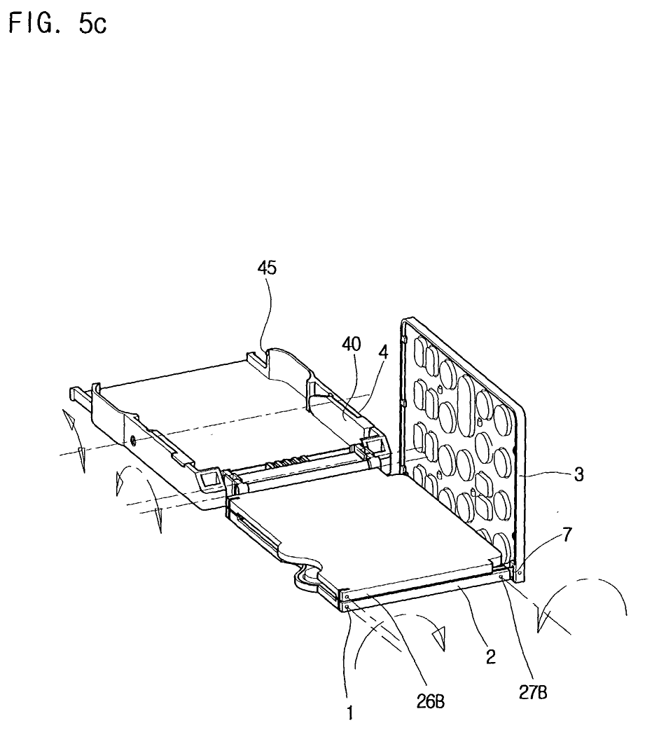

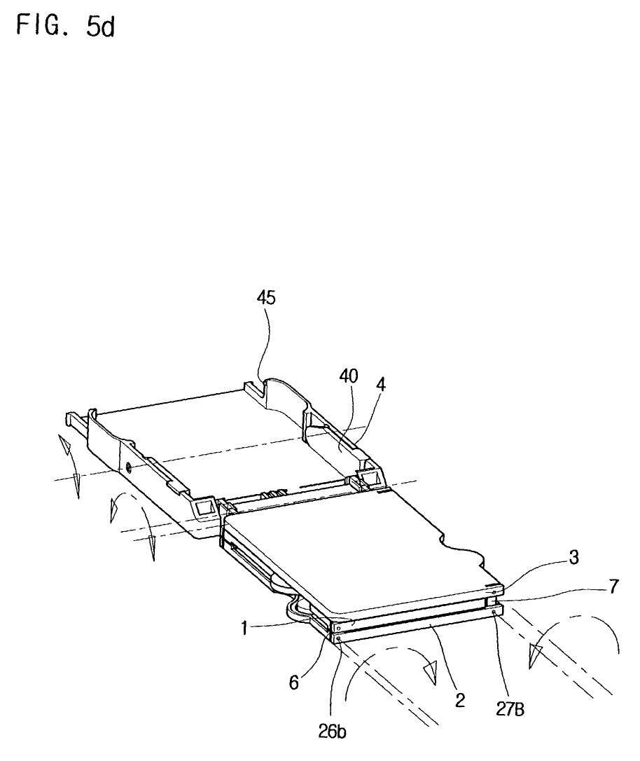

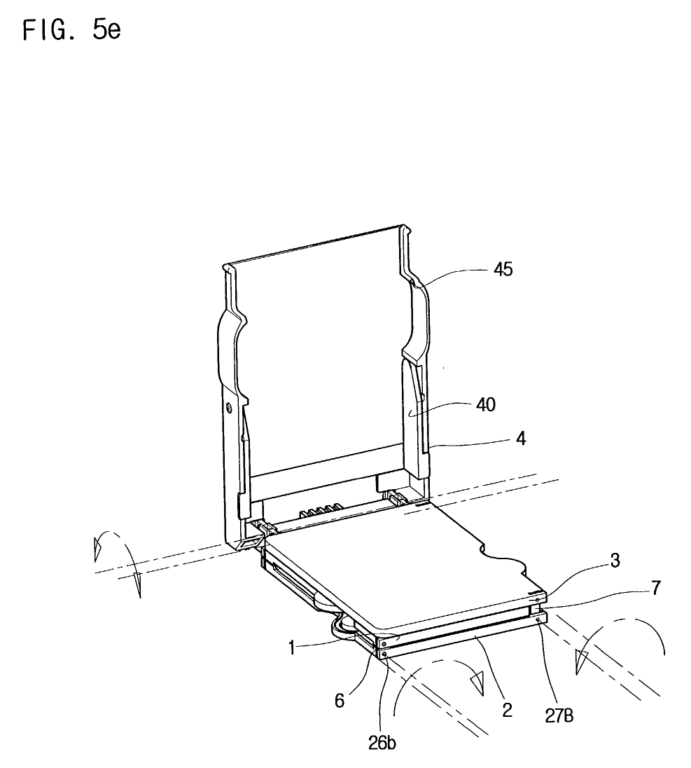

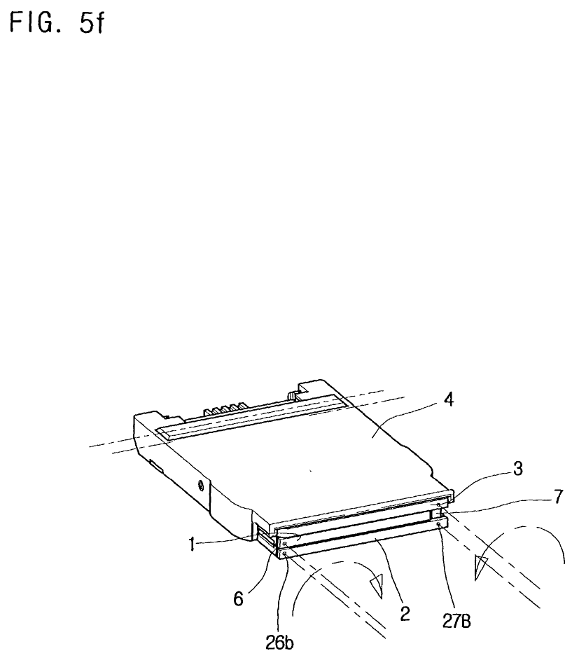

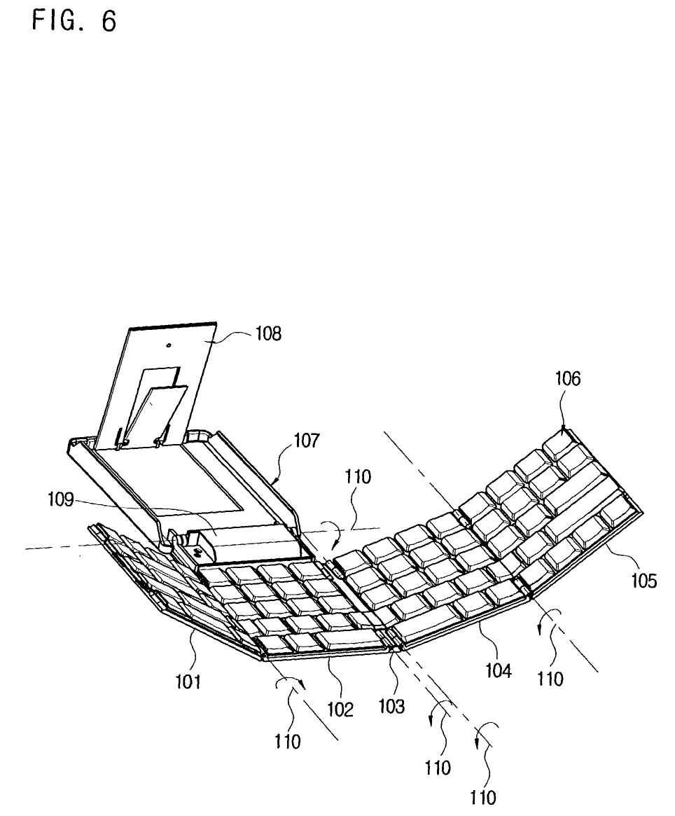

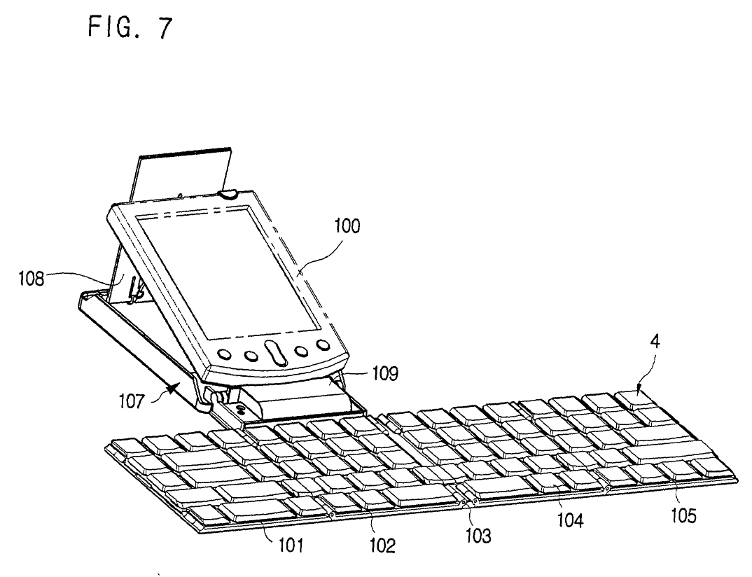

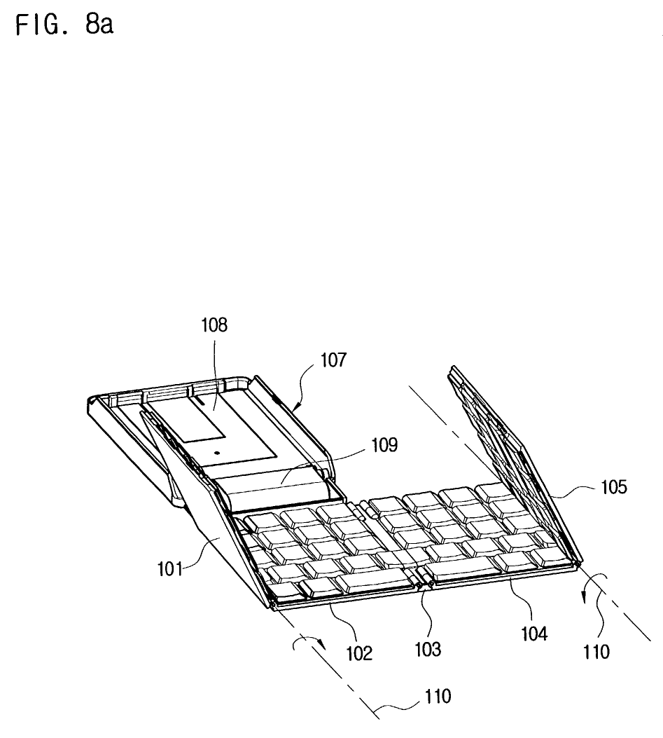

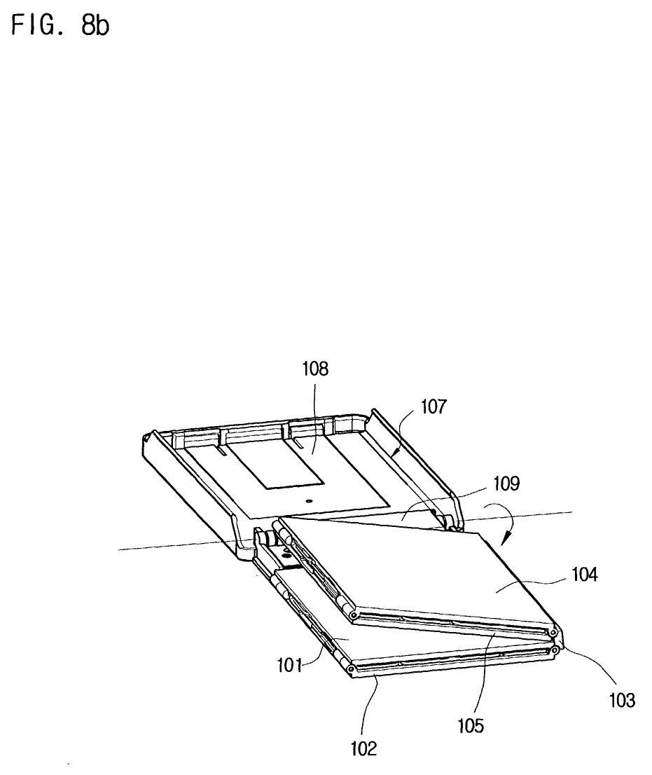

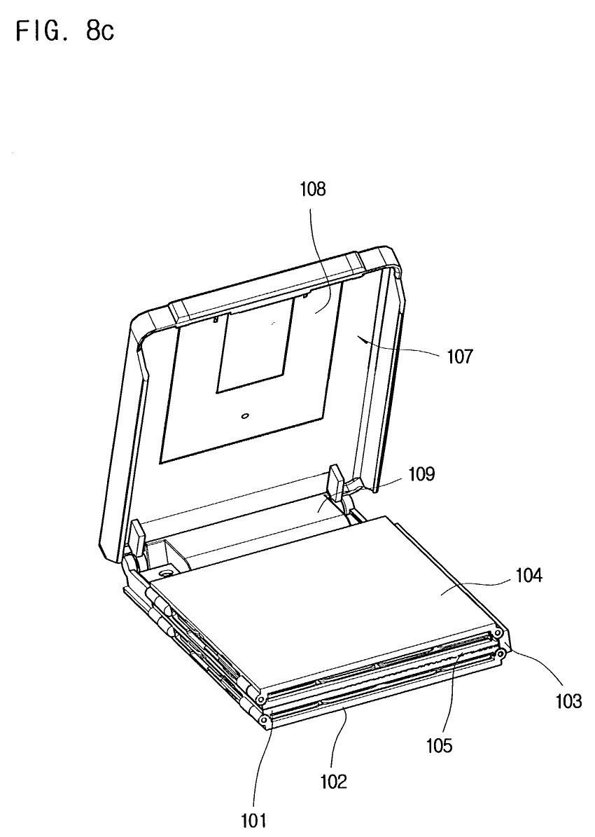

FIGS. 5a to 5f sequentially show a process for folding the portable keyboard of the present invention. First, as shown in FIGS. 5a and 5b, the first main frame 1 is folded into the second main frame 2. Herein, the first link blocks 6 rotate centering around the corresponding first hinge pins B 26B inserted into one side of the second main frame 2, thereby rotating the first main frame 1 to be folded into the second main frame 2.

Then, as shown in FIGS. 5c and 5d, the third main frame 3 is folded into the folded first main frame 1 into the second main frame 2. Herein, the second link blocks 7 rotate centering on the corresponding second hinge pins A 27B inserted into the other side of the second main frame 2, thereby rotating the third main frame 3 to be folded into the folded first main frame 1 into the second main frame 2. By making the second link block 7 to be longer than the first link block 6, the third main frame 3 can be folded into the first main frame 1 already folded into the second main frame 2.

Next, as shown in FIGS. 5e and 5f, the sub-frame 4 is folded into the folded structure of the first, second, and third main frames 1, 2, and 3 so as to cover the fooled structure. At this time, the fixing protrusions 45 formed on the both inner surfaces of the sub-frame 4 are inserted to the gap in the profile formed by folding first main frame 1 into the second main frame 2, thereby maintaining the folded condition of the portable keyboard of the present invention.

As apparent from the above description, the present invention provides a portable keyboard having a compact folded structure with a thin profile and a light weight formed by folding the three main frames, thereby being easy to carry and use.

The portable keyboard of the present invention comprises the rotatably-operated connector, thereby being easily connected to various kinds of portable communication terminals.

Further, the portable keyboard of the present invention comprises the holder supported by the supporting knolls of the sub-frame, thereby more firmly and stably holding a portable communication terminal.

Moreover, the key pad of the portable keyboard of the present invention is fixed to the main frames without bolts, thereby allowing the key pad to be swiftly and easily attached or detached from the main frames.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A portable keyboard comprising a plurality of laterally arranged main frames provided with a key pad attached thereto, a sub-frame longitudinally connected to one main frame selected from the plural main frames and provided with a folding holder, and a connector connected to the main frame where the sub-frame is longitudinally connected,
wherein the main frame comprises first, second, and third main frames, the sub-frame is connected to the second main frame, and the first main frame is rotatably connected to the second main frame by a first link block and the third main frame is rotatably connected to the second main frame by a second link block being longer than the first link block.

2. The portable keyboard as set forth in claim 1, wherein an extension is formed on one side of the second main frame, the extension comprises a supporting protrusion upwardly protruded from its both ends and front and rear insertion holes with opened upper ends formed on both external side surfaces of the supporting protrusions, and wherein hinge axes inwardly protruding from the inner surfaces of both ends of the sub-frame are rotatably inserted into the corresponding front insertion holes of the supporting protrusions, and hinge protrusions protruding from both ends of the connector are rotatably inserted into the corresponding rear insertion holes of the supporting protrusions.

3. The portable keyboard as set forth in claim 1, wherein a holder is disposed within the sub-frame, the holder comprises both supporting plates and a horizontal bar for interconnecting two supporting plates to each other, formed on the upper surfaces of the supporting plates, a rotary protrusion is protruded from the external side surface of each supporting plate so as to be inserted into a rotary protrusion insertion hole formed on both inner surfaces of the sub-frame, an incline place is formed on the rear portion of the lower surface of each supporting plate so as to be supported by a supporting knoll protruded from the inner surface of the sub-frame in front of each rotary protrusion insertion hole, and fixing protrusions are formed on the holder 41 at the upper position of the rotary protrusions and fixing protrusions are formed on the sub-frame.

4. The portable keyboard as set forth in claim 1, wherein a plurality of fixing holes are formed at several locations of the key pad, a plurality of hooks are formed on the bottom surfaces of the first, second, and third main frames so as to correspond to the fixing holes of the key pad, and the key pad is attached to the first, second, and third main frames by only inserting the hooks into the corresponding fixing holes.
